(19) United States
(12) Patent Application Publication
(10) Pub. No.: US 2011/0051070 A1
(43) Pub. Date: Mar. 3, 2011

(54) LIQUID CRYSTAL DISPLAY DEVICE

(75) Inventors: Susumu SASAKI, Chiba (JP); Katsuyuu Takahashi, Mobara (JP); Tetsuya Nagata, Mobara (JP); Hitoshi Azuma, Yokohama (JP); Tomio Yaguchi, Sagamihara (JP); Yasushi Nakano, Tokyo (JP)

(73) Assignee: Hitachi Displays, Ltd.

(21) Appl. No.: 12/862,970

(22) Filed: Aug. 25, 2010

(30) Foreign Application Priority Data
Aug. 25, 2009 (JP) 2009-193938

(51) Int. Cl. G02F 1/1333

(52) U.S. Cl. 349/158

(57) ABSTRACT

In a liquid crystal display device including: a first substrate and a second substrate; and a liquid crystal layer which is arranged between the first substrate and the second substrate, the first substrate includes a resin substrate having conductivity and a polarizer, the polarizer is arranged on a surface of the resin substrate on a side opposite to a surface of the resin substrate which faces the second substrate in an opposed manner, a main surface of the resin substrate includes an exposure portion which exposes a portion of the main surface of the resin substrate from a main surface of the polarizer, a plurality of lines are formed on the second substrate, and the first substrate is electrically connected with at least one of the plurality of lines via the exposure portion.

### CROSS-REFERENCE TO RELATED APPLICATION

The present application claims priority from Japanese application JP 2009-193938 filed on Aug. 25, 2009, the content of which is hereby incorporated by reference into this application.

### BACKGROUND OF THE INVENTION

The present invention relates to a liquid crystal display device, and more particularly to a liquid crystal display device which can improve mechanical strength of the liquid crystal display device where a first substrate (for example, a substrate on which color filters are formed) and a second substrate (for example, a substrate on which thin film transistors are formed) are arranged to face each other in an opposed manner and a liquid crystal layer is arranged between both substrates, and can ensure the stable electrical connection between lines formed on the substrate on which the thin film transistors are formed and the substrate on which the color filters are formed.

The liquid crystal display device has been popularly used in various kinds of equipments such as a mobile phone or personal digital assistant. Recently, to realize the reduction of thickness, the reduction of weight and bending (imparting of flexibility) of a display screen of a liquid crystal display device, a thin glass substrate or a resin substrate is used as a substrate material for forming the liquid crystal display device.

Further, as shown in JP-A-9-105918 (patent document 1) or the like, a lateral-electric-field liquid crystal display device is configured such that pixel electrodes and common electrodes are formed on a substrate side on which thin film transistors are formed, and an electric field is generated parallel to the substrate. In such a lateral electric field drive method, electrodes for driving liquid crystal molecules are not formed on a substrate on which color filters are formed. Accordingly, when a high potential such as static electricity is applied from the outside of a surface of a liquid crystal display panel, there arises a drawback that an abnormal display occurs. Accordingly, as disclosed in JP-A-9-105918, it is necessary to provide a conductive film to a surface of the substrate on which the color filters are formed opposite to a surface of the substrate which faces a substrate on which thin film transistors are formed in an opposed manner.

FIG. 9A and FIG. 9B show one example of a liquid crystal display panel used in a conventional liquid crystal display device where a glass substrate (substrate SUB1) on which color filters are formed and a glass substrate (substrate SUB2) on which thin film transistors (hereinafter referred to as “TFTs”) are formed are arranged to face each other in an opposed manner, and a liquid crystal layer is formed between both substrates. Further, polarizers PO1, PO2 are arranged on outer surfaces of both substrates.

FIG. 9A is constituted of a plan view and a cross-sectional view of the liquid crystal display panel, and FIG. 9B is an enlarged view of a region surrounded by a dotted line “a”. As shown in the plan view of FIG. 9A, an area (lateral length: B, longitudinal length: D) of the polarizer PO1 is set smaller than an area (lateral length: A, longitudinal length: C) of the substrate SUB1 (A>B or C>D). This area setting is made to enable the electrical grounding on a substrate SUB1 side. That is, as shown in FIG. 10A and FIG. 10B, by exposing a portion of the substrate SUB1 from the polarizer PO1, it is possible to ensure a region where the electrical connection is established using a conductive paste BP.

FIG. 10A and FIG. 10B show a mode in which flexible printed circuit board lines FPC (hereinafter referred to as “FPC lines”) are connected to the liquid crystal display panel shown in FIG. 9, wherein FIG. 10A is a perspective view and FIG. 10B is a cross-sectional view of an electrically connected portion. Lines CL for connection with the FPC lines are formed on the substrate SUB2. On a surface of the substrate SUB1 on a side opposite to a surface of the substrate SUB1 which faces the substrate SUB2 in an opposed manner, a transparent conductive film CON made of ITO or the like is formed so as to impart conductivity to the surface. Further, the transparent conductive film CON and a grounding line out of the lines CL are electrically connected with each other using a conductive paste BP such as a silver paste. Symbol SE indicates a sealing member which is provided for sealing liquid crystal LC between both substrates.

### SUMMARY OF THE INVENTION

In the conventional liquid crystal display device, although a thickness of the glass substrate is approximately 0.2 mm to 0.5 mm, there may be a case where the thickness of the glass substrate is decreased to 0.05 mm or less for realizing the reduction of thickness, the reduction of weight, bending of a display screen of the liquid crystal display device or the like. In such a case, at the time of forming a transparent conductive film on the substrate SUB1 using an ITO vacuum sputtering method or a coating method of a conductive coating material or the like, there arises a drawback that the substrate SUB1 is easily broken.

Further, by applying conductivity to the polarizer PO1 instead of forming a transparent conductive film on the substrate SUB1, the liquid crystal display device is expected to take the similar countermeasure against static electricity. However, the polarization characteristic of the polarizer (polyvinyl alcoholic material) is generated by stretching the polarizer in a manufacturing step thereof and hence, the shrinkage of the polarizer is liable to occur with time. Accordingly, even when electrical grounding is applied to the polarizer using the conductive paste or the like, there arises a drawback that the defective connection between the conductive paste and the conductivity applied surface is liable to occur due to the shrinkage of the polarizer.

The present invention has been made to overcome the above-mentioned drawbacks, and it is an object of the present invention to provide a liquid crystal display device which can improve mechanical strength of the liquid crystal display device and, at the same time, can ensure the electrical connection between lines formed on a second substrate (a substrate on which thin film transistors are formed, for example) and a first substrate (a substrate on which color filters are formed, for example).

The display device according to the present invention has following technical features to overcome the above-mentioned drawbacks.

(1) The present invention is directed to a liquid crystal display device including: a first substrate and a second substrate which are arranged to face each other in an opposed manner; and a liquid crystal layer which is arranged between the first substrate and the second substrate, wherein the first substrate includes a resin substrate having conductivity and a polarizer, the polarizer is arranged on a surface of the resin substrate on a side opposite to a surface of the resin substrate which faces the second substrate in an opposed manner, a main surface of the resin substrate includes an exposure portion which exposes a portion of the main surface of the resin substrate from a main surface of the polarizer, a plurality of lines are formed on the second substrate, and the first substrate is electrically connected with at least one of the plurality of lines via the exposure portion.

(2) In the liquid crystal display device having the above-mentioned constitution (1), an area of the main surface of the polarizer is set smaller than an area of the main surface of the resin substrate.

(3) In the liquid crystal display device having the above-mentioned constitution (1), the resin substrate has a notched portion, and the exposure portion is formed on the notched portion.

(4) In the liquid crystal display device having the above-mentioned constitution (1), the resin substrate has a projecting portion which is formed in a projecting manner from the main surface of the polarizer, and the exposure portion is formed on the projecting portion.

(5) In the liquid crystal display device having any one of the above-mentioned constitutions (1) to (4), a conductive film is formed on a surface of the resin substrate on a side opposite to a surface of the resin substrate which faces the second substrate in an opposed manner.

(6) In the liquid crystal display device having any one of the above-mentioned constitutions (1) to (5), color filters are formed on the first substrate, and thin film transistors are formed on the second substrate.

(7) In the liquid crystal display device having any one of the above-mentioned constitutions (1) to (5), color filters and thin film transistors are formed on the second substrate.

(8) In the liquid crystal display device having any one of the above-mentioned constitutions (1) to (6), the first substrate includes a first glass substrate on which color filters are formed, and the resin substrate is arranged on a surface of the first glass substrate on a side opposite to a surface of the first glass substrate which faces the second substrate.

(9) In the liquid crystal display device having the above-mentioned constitution (8), a thickness of the first glass substrate is 0.05 mm or less.

(10) In the liquid crystal display device having any one of the above-mentioned constitutions (1) to (6), color filters are formed on the resin substrate.

(11) In the liquid crystal display device having any one of the above-mentioned constitutions (1) to (10), the second substrate includes a second glass substrate and a second resin substrate, thin film transistors are formed on the second glass substrate, and the second resin substrate is arranged on a surface of the second glass substrate on a side opposite to a surface of the second glass substrate which faces the first substrate.

(12) In the liquid crystal display device having the above-mentioned constitution (11), a thickness of the second glass substrate is 0.05 mm or less.

(13) In the liquid crystal display device having any one of the above-mentioned constitutions (1) to (10), a thickness of the second glass substrate is 0.05 mm or less.

(14) In the liquid crystal display device having any one of the above-mentioned constitutions (1) to (13), the liquid crystal display device includes a plurality of pixels, pixel electrodes which are formed for the plurality of respective pixels, and common electrodes which generate an electric field between the pixel electrodes and the common electrodes, and the pixel electrodes and the common electrodes are formed on the second substrate.

According to the present invention, the substrate on which color filters are formed is formed using the resin substrate and hence, it is possible to enhance the mechanical strength of the liquid crystal display device. Further, by imparting the conductivity to the resin substrate and by establishing the electrical connection at the portion of the resin substrate which is exposed from the polarizer, it is possible to ensure the stable electrical connection between the lines formed on the second substrate (for example, the substrate on which the thin film transistors are formed) and the first substrate (for example, the substrate on which the color filters are formed).

### BRIEF DESCRIPTION OF THE DRAWINGS

FIG. 1A and FIG. 1B are views for explaining a first embodiment of a liquid crystal display panel used in the liquid crystal display device of the present invention;

FIG. 2A and FIG. 2B are views for explaining a mode of connection between the liquid crystal display panel shown in FIG. 1 and FPC lines;

FIG. 3A and FIG. 3B are views for explaining a second embodiment of a liquid crystal display panel used in the liquid crystal display device of the present invention;

FIG. 4A and FIG. 4B are views for explaining a third embodiment of a liquid crystal display panel used in the liquid crystal display device of the present invention;

FIG. 5A and FIG. 5B are views for explaining a fourth embodiment of a liquid crystal display panel used in the liquid crystal display device of the present invention;

FIG. 6A and FIG. 6B are views for explaining a mode of connection between the liquid crystal display panel shown in FIG. 5 and FPC lines;

FIG. 7A and FIG. 7B are views for explaining a fifth embodiment of a liquid crystal display panel used in the liquid crystal display device of the present invention;

FIG. 8A and FIG. 8B are views for explaining a mode of connection between the liquid crystal display panel shown in FIG. 7 and FPC lines;

FIG. 9A and FIG. 9B are views for explaining a liquid crystal display panel used in a conventional liquid crystal display device; and

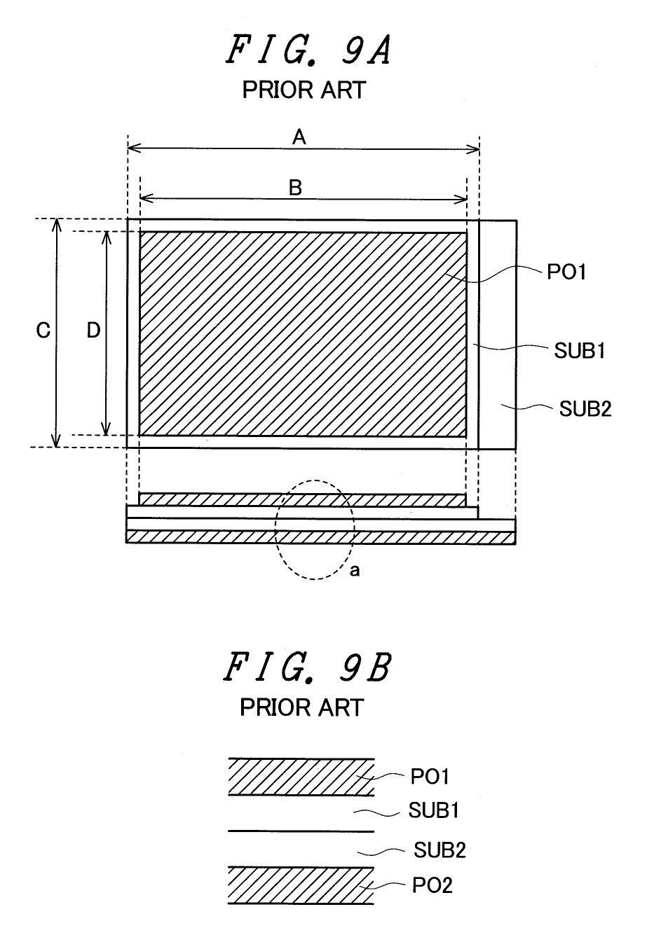

FIG. 10A and FIG. 10B are views for explaining a mode of connection between the conventional liquid crystal display panel shown in FIG. 9 and FPC lines.

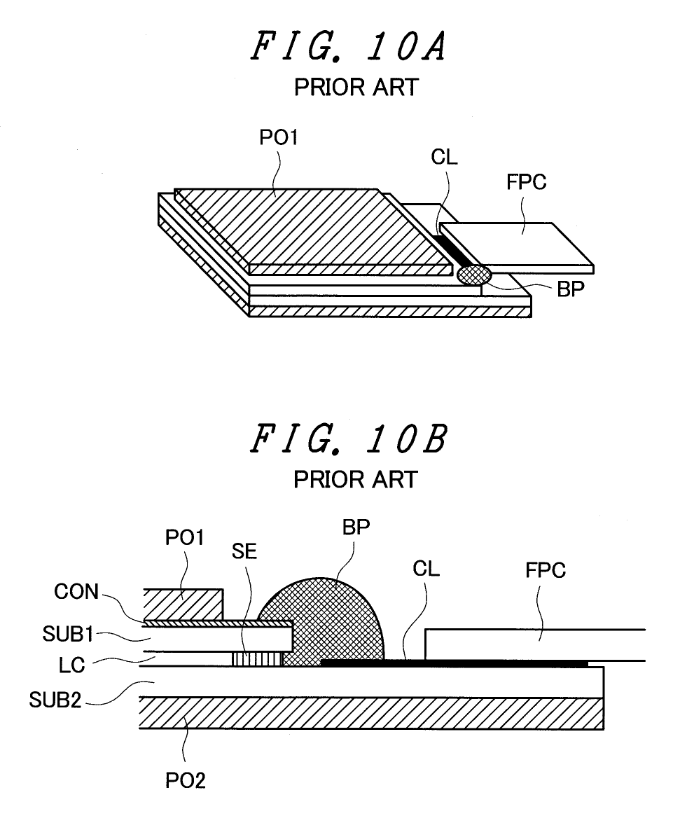

### DETAILED DESCRIPTION OF THE INVENTION

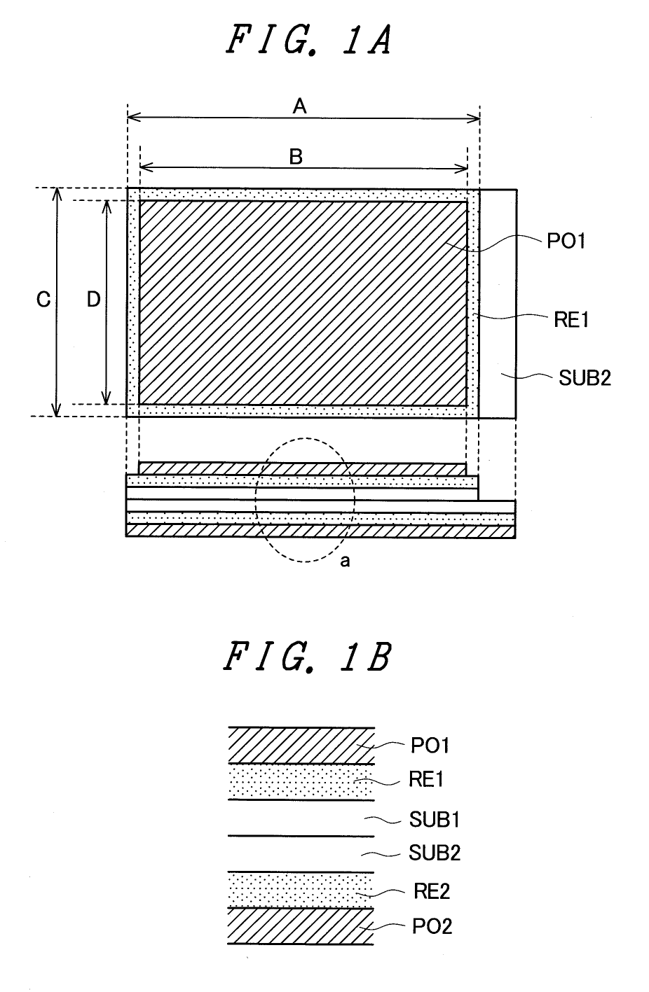

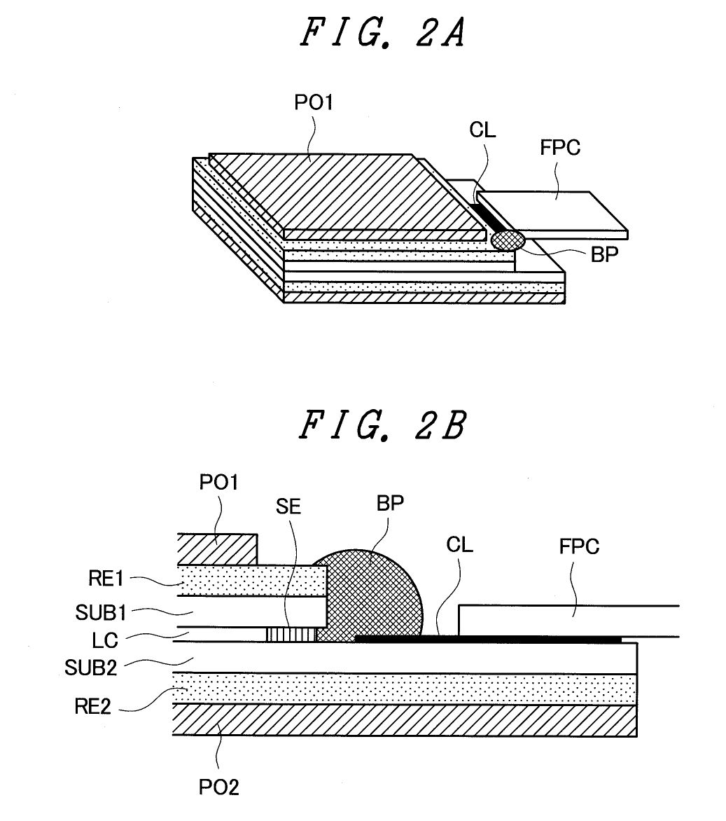

A liquid crystal display device according to the present invention is explained in detail hereinafter. FIG. 1A and FIG. 1B are views showing a first embodiment of a liquid crystal display panel used in a liquid crystal display device of the present invention. Further, FIG. 2A and FIG. 2B show a mode in which the liquid crystal display panel shown in FIG. 1 and flexible printed circuit board lines (FPC lines) are connected to each other.

The liquid crystal display device of the present invention is characterized in that, in the liquid crystal display device where a substrate on which thin film transistors are formed and a substrate on which color filters are formed are arranged to face each other in an opposed manner, and a liquid crystal layer is arranged between both substrates, a resin substrate RE1 to which conductivity is imparted is formed on a substrate side on which the color filters are formed, a polarizer Pal is formed on an outer surface (surface opposite to a liquid crystal layer) of the resin substrate, an area of the polarizer PO1 is set smaller than an area of the outer surface of the resin substrate, and the electrical connection is made by making use of a portion of the outer surface of the resin substrate exposed from the polarizer.

In the first embodiment, with respect to the glass substrate (substrate SUB1) on which the color filters are formed, the color filters are formed on a liquid-crystal-layer side (a surface side which faces the substrate SUB2 in an opposed manner) of the glass substrate (substrate SUB1), and the resin substrate RE1 is adhered to a side opposite to the liquid crystal layer (a surface opposite to the surface which faces the substrate SUB2 in an opposed manner) of the glass substrate (SUB1). Further, the polarizer PO1 is adhered to an outer surface of the resin substrate RE1. The substrate SUB1 is a thin plate having a thickness of 0.05 mm or less, and the resin substrate RE1 is provided for reinforcing the substrate SUB1. A thickness of the resin substrate RE1 is approximately 0.1 mm.

The resin substrate RE1 is formed by preferably using a heat resistant resin such as polyethylene naphthalate, a polyimide material or a polycarbonate material. Further, to prevent an abnormal display due to static electricity, conductivity is imparted to the resin substrate RE1. As a method for imparting conductivity, there has been known a method which forms a transparent conductive film made of ITO, polyaniline, polythiophene or the like on an outer surface of the resin substrate RE1, a method which uses a conductive material in a resin per se which constitutes the substrate, a method which adds a conductive material to the inside of a resin which constitutes the substrate or the like.

On the substrate SUB2, pixel electrodes and common electrodes which correspond to respective display pixels, thin film transistors which constitute switching elements for driving the electrodes and various lines such as signal lines, scanning lines and power supply lines are arranged. Particularly, in a lateral-electric-field liquid crystal display device, electric members such as the electrodes and the lines are concentrated on the substrate SUB2 side, and the electric members are not provided to the substrate SUB1 side at all and hence, the above-mentioned countermeasure to cope with static electricity is indispensable.

Also on the substrate SUB2 side, in the same manner as the substrate SUB1, a thickness of the substrate SUB2 per se is decreased, and a resin substrate RE2 is provided for reinforcing the substrate SUB2. Further, a polarizer PO2 can be adhered to an outer surface of the resin substrate RE2. Although a heat resistant resin may preferably be used as a material of the resin substrate RE2 in the same manner as the resin substrate RE1 on the substrate SUB1 side, as described previously, electrodes, the lines and the like are arranged on the substrate SUB2 side and hence, it is not particularly necessary to impart conductivity to the resin substrate RE2.

Liquid crystal LC is sealed between the substrate SUB2 and the substrate SUB1 using a sealing member SE as shown in FIG. 2B.

Lines CL for connecting signal lines, scanning lines, electricity supply lines not shown in the drawing which are formed on the substrate SUB2 with the outside of the liquid crystal display panel are formed on the substrate SUB2. Further, the lines CL also include a grounding line for the electrical connection with the substrate SUB1.

As shown in FIG. 2A and FIG. 2B, FPC lines are connected to the liquid crystal display panel, and more particularly to the lines CL of the substrate SUB2. Further, the resin substrate RE1 and the grounding line out of the lines CL are electrically connected with each other using a conductive paste BP such as a silver paste as shown in FIG. 2A and FIG. 2B.

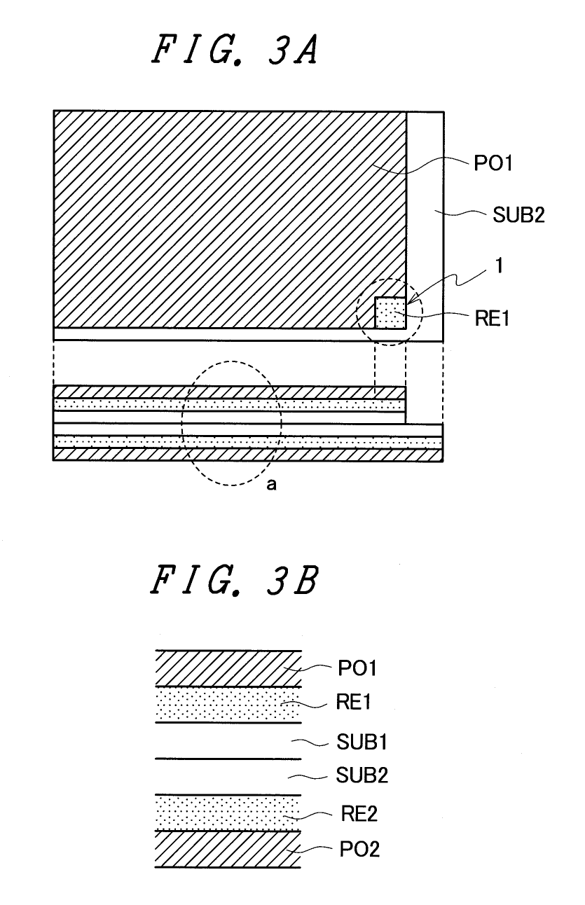

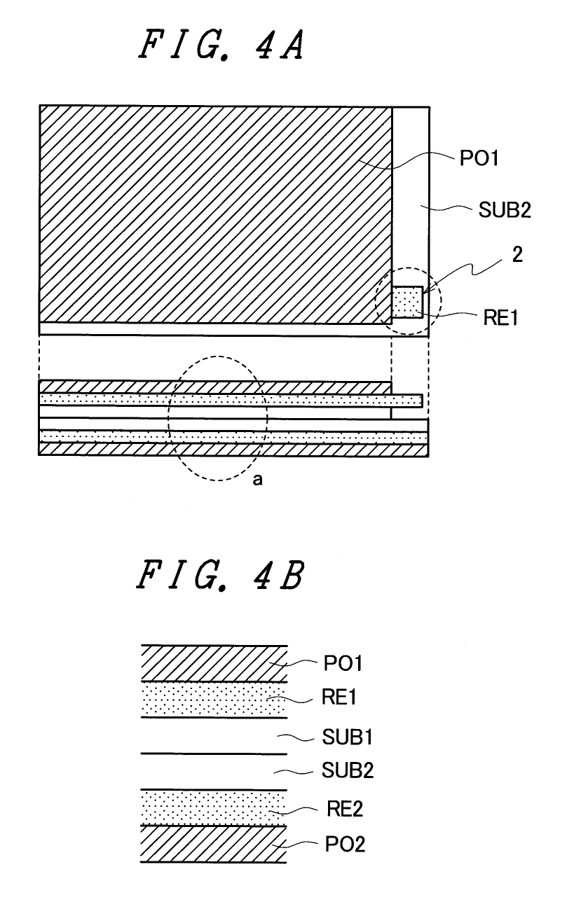

Next, the technical feature of the liquid crystal display device of the present invention is explained. That is, the constitution which makes an area of the polarizer PO1 smaller than an area of the outer surface of the resin substrate RE1 for establishing the electrical connection between the resin substrate RE1 and the lines CL is explained. FIG. 1A, FIG. 1B, FIG. 3A, FIG. 3B and FIG. 4A and FIG. 4B show various embodiments. FIG. 1A, FIG. 3A and FIG. 4A are plan views and cross-sectional views of the liquid crystal display panel, and FIG. 1B, FIG. 3B and FIG. 4B are enlarged views showing a region indicated by a dotted line “a” in FIG. 1A, FIG. 3A and FIG. 4A which are cross-sectional views.

In the first embodiment shown in FIG. 1A and FIG. 1B, an area (lateral length: B, longitudinal length: D) of a main surface of the polarizer PO1 is set smaller than an area (lateral length: A, longitudinal length: C) of a main surface of the resin substrate RE1 (A>B or C>D).

Further, in the second embodiment shown in FIG. 3A and FIG. 3B, a notched portion 1 is formed in a portion of the polarizer PO1 so as to expose a portion of the resin substrate RE1.

Further, in the third embodiment shown in FIG. 4A and FIG. 4B, a portion of the resin substrate RE1 is formed as a projection portion 2 which projects from the polarizer PO1 in a tab shape so as to expose the portion of the resin substrate RE1.

In all of first to third embodiments, the glass substrate (substrate SUB1) on which the color filters are formed and the glass substrate (substrate SUB2) on which the thin film transistors are formed are used as an example. However, the above-mentioned constitution may be adopted as a method for exposing a portion of a resin substrate from a polarizer also in the constitution of various substrates described later in the same manner.

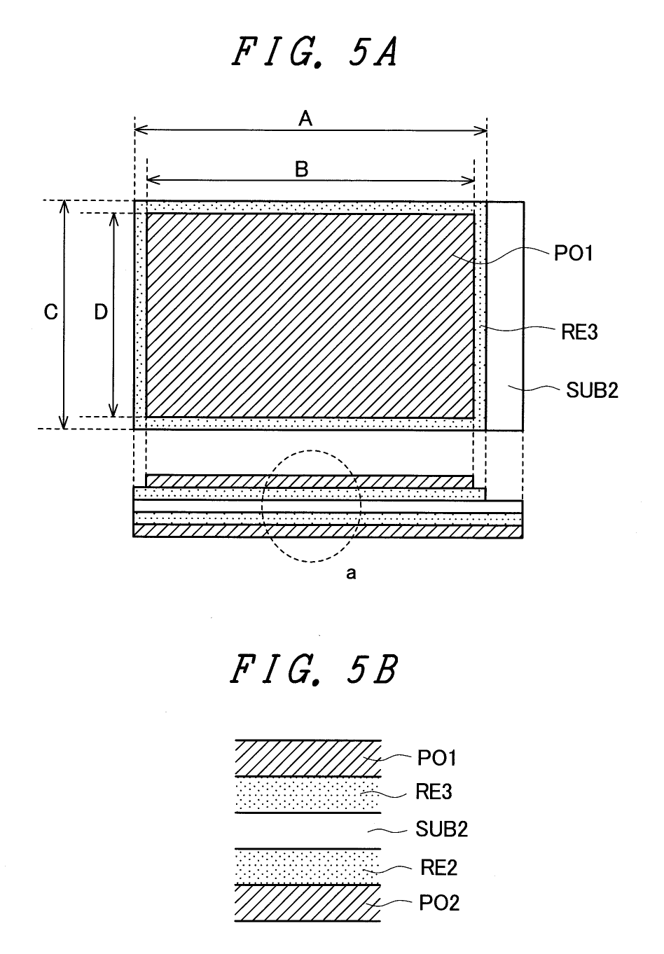

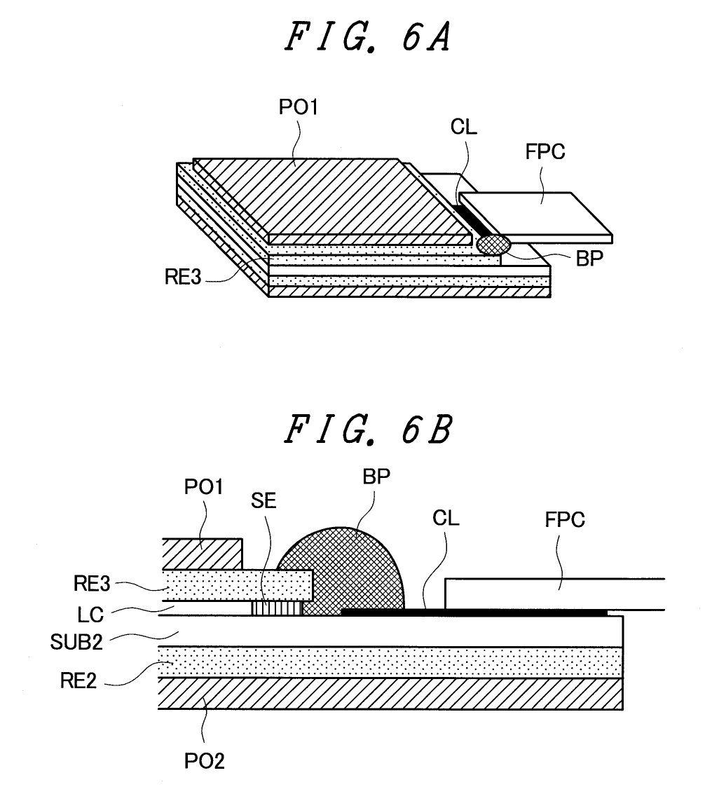

FIG. 5A, FIG. 5B, FIG. 6A and FIG. 6B show a liquid crystal display device according to a fourth embodiment of the present invention. In the fourth embodiment, a resin substrate RE3 is used as a substrate on which color filters are formed. By directly forming the color filters on the resin substrate RE3, it is unnecessary to use a glass substrate as a color-filter-side substrate thus realizing a further reduction of weight and the further bending of a display screen.

A polarizer PO1 is formed on an outer surface of the resin substrate RE3 and, in the same manner as the constitution shown in FIG. 1, an area of the polarizer PO1 is set smaller than an area of the resin substrate RE3. As a material for forming the resin substrate RE3, a material substantially equal to the material for forming the resin substrate RE1 of the first embodiment can be used. Further, in the same manner as the resin substrate RE1 of the first embodiment, conductivity is imparted to the resin substrate RE3.

As shown in FIG. 5A and FIG. 5B or FIG. 6A and FIG. 6B, with respect to a substrate side on which thin film transistors are formed, in the same manner as the first to third embodiments, the thin film transistors and the like are formed on a substrate SUB2, and a resin substrate RE2 and a polarizer PO2 are sequentially arranged on an outer surface of the substrate SUB2. As shown in FIG. 6B, a space is defined between the substrate SUB2 and the resin substrate RE3, and liquid crystal LC is sealed in the space using a sealing member SE.

FIG. 6A and FIG. 6B show a mode in which a liquid crystal display panel shown in FIG. 5 and FPC lines are connected to each other. The resin substrate RE3 to which conductivity is imparted and a grounding line (included in the lines CL) on the substrate SUB2 are electrically connected with each other using a conductive paste BP.

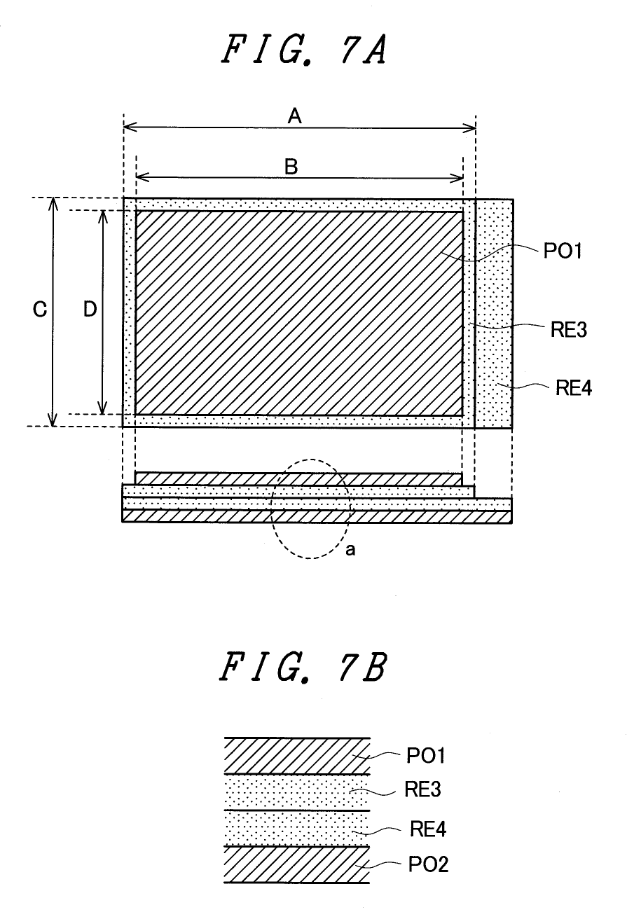

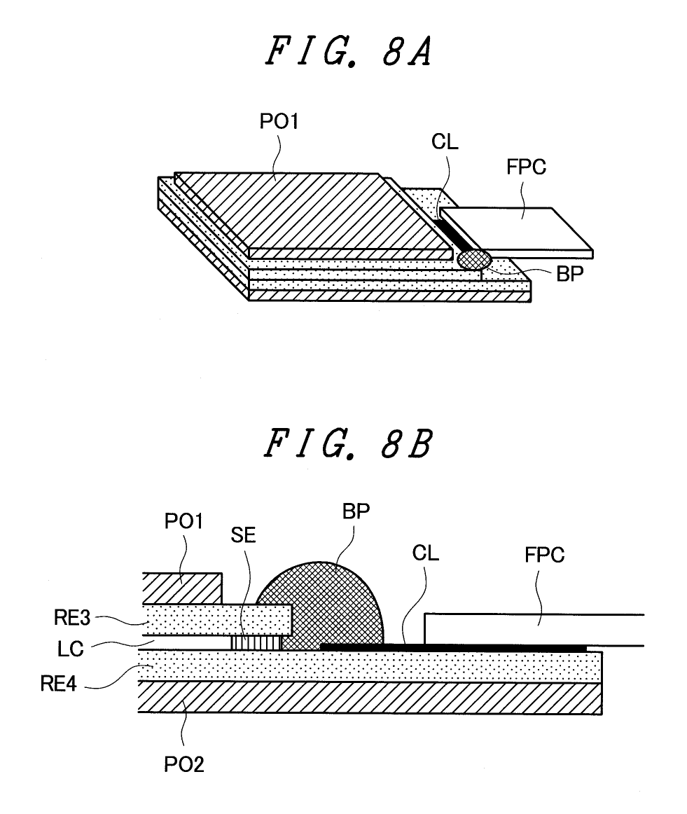

FIG. 7A, FIG. 7B, FIG. 8A and FIG. 8B show a liquid crystal display device according to a fifth embodiment of the present invention. In the fifth embodiment, a resin substrate RE3 is used as a substrate on which color filters are formed, and a resin substrate RE4 is used as a substrate on which thin film transistors are formed. By directly forming the color filters, thin film transistors and the like on the resin substrate RE3 or RE4, it is unnecessary to use a glass substrate as a substrate which constitutes the liquid crystal display panel thus realizing the further reduction of weight and the further bending of a display screen.

The color filters are formed on an inner surface (a surface which faces a liquid crystal layer in an opposed manner) of the resin substrate RE3, and thin film transistors and various electrodes and lines are formed on an inner surface of the resin substrate RE4. As a method of forming the thin film transistors and various electrodes and lines on the resin substrate RE4, for example, a method in which thin film transistors and various electrodes and lines are firstly formed on a glass substrate, and the thin film transistors and various electrodes and lines are transferred to the resin substrate RE4 is named. Further, in the same manner as the first to fourth embodiments, conductivity is imparted to the resin substrate RE3 and, as shown in FIG. 8, the resin substrate RE3 is electrically connected with the lines CL formed on the resin substrate RE4 using a conductive paste BP.

On outer surfaces of the respective resin substrates (RE3, RE4), polarizers (PO1, PO2) are formed. Particularly, an area of the polarizer PO1 is set smaller than an area of an outer surface of the resin substrate RE3.

In the above-mentioned first to fifth embodiments, irrelevant to whether the substrate SUB1, SUB2 is formed of the glass substrate or the resin substrate, the constitution where out of the pair of substrates, the thin film transistors and various electrodes and lines are formed on one substrate, and the color filters are formed on the other substrate is described. However, the present invention is also applicable to the constitution where color filters are also formed on one substrate together with the thin film transistors and various electrodes and lines and the resin substrate RE1 or RE3 to which conductivity is imparted is formed on the other substrate (so-called color filter-ON-TFT structure).

As has been explained heretofore, according to the present invention, it is possible to provide the liquid crystal display device which can improve the mechanical strength of the liquid crystal display device, and to ensure the stable electrical connection between the lines formed on the substrate on which the thin film transistors are formed and the substrate on which the color filters are formed.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising:
a first substrate and a second substrate which are arranged to face each other in an opposed manner; and
a liquid crystal layer which is arranged between the first substrate and the second substrate, wherein
the first substrate includes a resin substrate having conductivity and a polarizer,
the polarizer is arranged on a surface of the resin substrate on a side opposite to a surface of the resin substrate which faces the second substrate in an opposed manner,
a main surface of the resin substrate includes an exposure portion which exposes a portion of the main surface of the resin substrate from a main surface of the polarizer,
a plurality of lines are formed on the second substrate, and
the first substrate is electrically connected with at least one of the plurality of lines via the exposure portion.

2. The liquid crystal display device according to claim 1, wherein an area of the main surface of the polarizer is set smaller than an area of the main surface of the resin substrate.

3. The liquid crystal display device according to claim 1, wherein the resin substrate has a notched portion, and the exposure portion is formed on the notched portion.

4. The liquid crystal display device according to claim 1, wherein the resin substrate has a projecting portion which is formed in a projecting manner from the main surface of the polarizer, and
the exposure portion is formed on the projecting portion.

5. The liquid crystal display device according to claim 1, wherein a conductive film is formed on a surface of the resin substrate on a side opposite to a surface of the resin substrate which faces the second substrate in an opposed manner.

6. The liquid crystal display device according to claim 1, wherein color filters are formed on the first substrate, and thin film transistors are formed on the second substrate.

7. The liquid crystal display device according to claim 1, wherein color filters and thin film transistors are formed on the second substrate.

8. The liquid crystal display device according to claim 1, wherein the first substrate includes a first glass substrate on which color filters are formed, and
the resin substrate is arranged on a surface of the first glass substrate on a side opposite to a surface of the first glass substrate which faces the second substrate.

9. The liquid crystal display device according to claim 8, wherein a thickness of the first glass substrate is 0.05 mm or less.

10. The liquid crystal display device according to claim 1, wherein color filters are formed on the resin substrate.

11. The liquid crystal display device according to claim 1, wherein the second substrate includes a second glass substrate and a second resin substrate,
thin film transistors are formed on the second glass substrate, and
the second resin substrate is arranged on a surface of the second glass substrate on a side opposite to a surface of the second glass substrate which faces the first substrate.

12. The liquid crystal display device according to claim 11, wherein a thickness of the second glass substrate is 0.05 mm or less.

13. The liquid crystal display device according to claim 1, wherein the second substrate includes a second resin substrate, and thin film transistors are formed on the second resin substrate.

14. The liquid crystal display device according to claim 1, wherein the liquid crystal display device includes a plurality of pixels, pixel electrodes which are formed for the plurality of respective pixels, and common electrodes which generate an electric field between the pixel electrodes and the common electrodes, and the pixel electrodes and the common electrodes are formed on the second substrate.
